(19) United States
(12) Patent Application Publication
(10) Pub. No.: US 2019/0286130 A1
(43) Pub. Date: Sep. 19, 2019

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventors: Masamitsu Tsuchiya, Wako-shi (JP); Hideki Matsunaga, Wako-shi (JP); Yasuharu Hashimoto, Wako-shi (JP); Etsuo Watanabe, Wako-shi (JP); Ryoma Taguchi, Tokyo (JP)

(21) Appl. No.: 16/297,749

(22) Filed: Mar. 11, 2019

(30) Foreign Application Priority Data
Mar. 13, 2018 (JP) 2018-045904

(51) Int. Cl. G05D 1/00; G06K 9/00; B60W 50/14; G05D 1/02

(52) U.S. Cl. CPC G05D 1/0061; G06K 9/00798; G05D 1/0223; B60W 50/14; G06K 9/00805

(57) ABSTRACT

A vehicle control device includes a recognition unit that recognizes a surrounding situation of a vehicle, a driving control unit that executes a first driving mode in which steering, and speed of the vehicle are controlled or a second driving mode in which a degree of dependence on the operation of the occupant is higher than the first driving mode on the basis of the surrounding situation recognized by the recognition unit, and a switching controller that switches between the first driving mode and the second driving mode, wherein the driving control unit switches a traveling line of the vehicle from a first traveling line on which the vehicle travels in the first driving mode to a second traveling line on which the vehicle travels in the second driving mode and then switches a driving mode of the vehicle from the first driving mode to the second driving mode.

### CROSS-REFERENCE TO RELATED APPLICATION

Priority is claimed on Japanese Patent Application No. 2018-045904, filed Mar. 13, 2018, the content of which is incorporated herein by reference.

### BACKGROUND

### Field of the Invention

The present invention relates to a vehicle control device, a vehicle control method, and a storage medium.

### Description of Related Art

In recent years, research on automated vehicle control has been proceeding. In relation thereto, a technology for preventing a gap from occurring between a traveling line at the time of automated driving of a vehicle and a traveling line at the time of manual driving (that is, a traveling line assumed by a driver) is disclosed (for example, Japanese Unexamined Patent Application, First Publication No. 2016-224594).

### SUMMARY

However, in the related art, even when an occupant starts manual driving in spite of a mismatch between a center position of the vehicle and a position at which the occupant is seated, the occupant may not be able to visually recognize a surrounding situation of the vehicle in a balanced manner because a traveling line of the vehicle is located in a traveling line at the time of automated driving with reference to the center position of the vehicle.

The present invention has been made in consideration of such circumstances, and an object of the present invention is to provide a vehicle control device, a vehicle control method, and a storage medium capable of realizing more desirable travel control at the time of switching between driving modes.

The vehicle control device, the vehicle control method, and the storage medium according to the present invention adopt the following configurations.

(1): A vehicle control device according to an aspect of the present invention includes: a recognition unit that recognizes a surrounding situation of a vehicle; a driving control unit that executes, on the basis of the surrounding situation recognized by the recognition unit, a first driving mode in which steering, acceleration, and deceleration of the vehicle are controlled without dependence on an operation of an occupant or a second driving mode in which a degree of dependence on the operation of the occupant is higher than the first driving mode; and a switching control unit that switches between the first driving mode and the second driving mode when a predetermined condition is satisfied, wherein the driving control unit switches a traveling line of the vehicle from a first traveling line on which the vehicle travels in the first driving mode to a second traveling line on which the vehicle travels in the second driving mode and then switches a driving mode of the vehicle from the first driving mode to the second driving mode.

(2): In the aspect (1), the driving control unit sets the first traveling line and the second traveling line to the same lane.

(3): In the aspect (1), the driving control unit sets the first traveling line and the second traveling line to different lanes in a case that the number of traveling lanes of the vehicle recognized by the recognition unit is equal to or greater than two.

(4): In the aspect (1), the switching control unit executes control for switching the driving mode of the vehicle from the first driving mode to the second driving mode in a case that an obstacle in a progression direction of the vehicle is recognized by the recognition unit.

(5): In the aspect (1), the switching control unit executes control for switching the driving mode of the vehicle from the first driving mode to the second driving mode in a case that a disturbance element of a road on which the vehicle travels, which is recognized by the recognition unit, is equal to or larger than a predetermined amount.

(6): A vehicle control method according to an aspect of the present invention is a vehicle control method including recognizing, by a vehicle control device, a surrounding situation of a vehicle; executing, by the vehicle control device, a first driving mode in which steering, acceleration, and deceleration of the vehicle are controlled without dependence on an operation of an occupant or a second driving mode in which a degree of dependence on the operation of the occupant is higher than the first driving mode on the basis of the recognized surrounding situation; switching, by the vehicle control device, between the first driving mode and the second driving mode when a predetermined condition is satisfied; and switching, by the vehicle control device, a traveling line of the vehicle from a first traveling line on which the vehicle travels in the first driving mode to a second traveling line on which the vehicle travels in the second driving mode and then switching a driving mode of the vehicle from the first driving mode to the second driving mode.

(7): A storage medium according to an aspect of the present invention is a computer-readable non-transient storage medium storing a program, the program causing a vehicle control device to: recognize a surrounding situation of a vehicle; execute a first driving mode in which steering, acceleration, and deceleration of the vehicle are controlled without dependence on an operation of an occupant or a second driving mode in which a degree of dependence on the operation of the occupant is higher than the first driving mode on the basis of the recognized surrounding situation; switch between the first driving mode and the second driving mode when a predetermined condition is satisfied; and switch a traveling line of the vehicle from a first traveling line on which the vehicle travels in the first driving mode to a second traveling line on which the vehicle travels in the second driving mode and then switch a driving mode of the vehicle from the first driving mode to the second driving mode.

According to (1) to (7), it is possible to realize more desirable travel control at the time of switching between the driving modes.

### BRIEF DESCRIPTION OF THE DRAWINGS

FIG. 1 is a configuration diagram of a vehicle system using a vehicle control device according to an embodiment.

FIG. 2 is a functional configuration diagram of a first control unit and a second control unit.

FIG. 3 is a diagram showing an example of a process of a traveling line control unit.

FIG. 4 is a diagram showing an example of a process of a traveling line control unit when the number of lanes of a road in which a subject vehicle travels is two.

FIG. 5 is a flowchart showing a flow of a process that is executed by the automated driving control device according to the embodiment.

FIG. 6 is a diagram showing an example of a hardware configuration of an automated driving control device according to an embodiment.

### DESCRIPTION OF EMBODIMENTS

Hereinafter, embodiments of a vehicle control device, a vehicle control method, and a storage medium according to the present invention will be described below with reference to the drawings. The vehicle control device of an embodiment is applied to an automatically driven vehicle. Driving modes that can be executed by the automatically driven vehicle include a first driving mode in which steering, acceleration, and deceleration of the vehicle are controlled without dependence on an operation of an occupant and the vehicle is caused to travel, and a second driving mode in which the vehicle is caused to travel in a state in which a degree of dependence on the operation of the occupant is higher than the first driving mode. The state in which the degree of dependence on the operation of the occupant is high is a state in which a predetermined task is imposed to the occupant, such as a state in which the occupant operates a driving operator to control one or both of steering and acceleration/deceleration of the vehicle. Further, it is assumed that the second driving mode includes a state in which driving support control such as a lane keeping assistance system (LKAS) or an adaptive cruise control system (ACC) is performed. Further, it is assumed that, in the following description, the “occupant” indicates an occupant that sits on a seat provided with a driver's seat, that is, a driving operator. Further, a case in which left-hand driving is applied will be described below, but right and left may be reversed in a case that right-hand driving is applied.

[Overall Configuration]

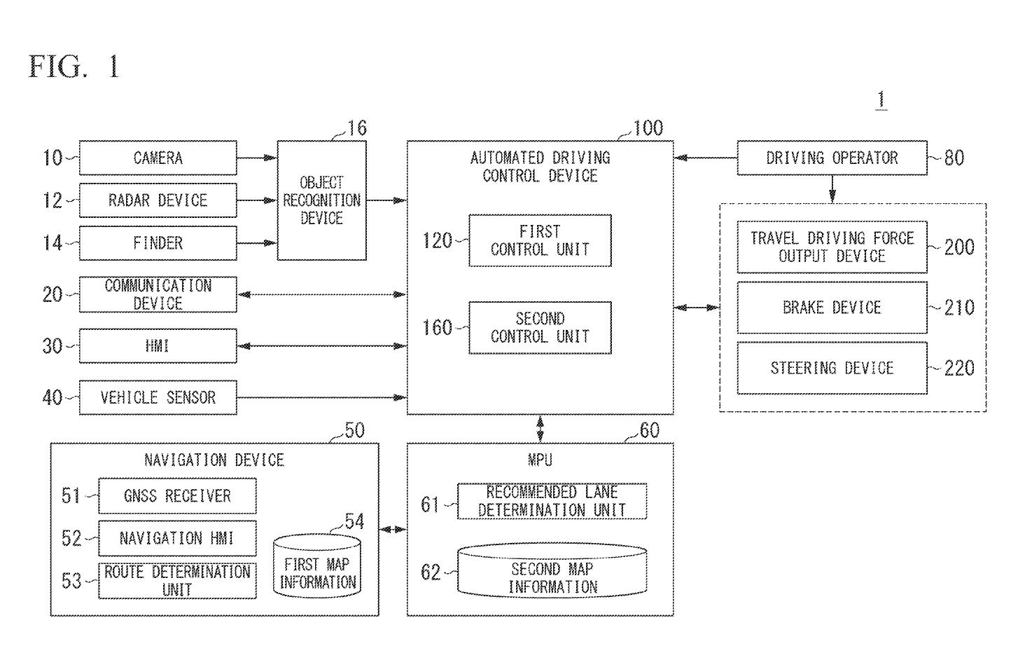

FIG. 1 is a configuration diagram of a vehicle system 1 using a vehicle control device according to an embodiment. A vehicle in which the vehicle system 1 is mounted is, for example, a vehicle such as a two-wheeled vehicle, a three-wheeled vehicle, or a four-wheeled vehicle. A driving source thereof is an internal combustion engine such as a diesel engine or a gasoline engine, an electric motor, or a combination thereof. The electric motor operates using power generated by a power generator connected to the internal combustion engine or discharge power of a secondary battery or a fuel cell.

The vehicle system 1 includes, for example, a camera 10, a radar device 12, a finder 14, an object recognition device 16, a communication device 20, a human machine interface (HMI) 30, a vehicle sensor 40, a navigation device 50, a map positioning unit (MPU) 60, a driving operator 80, an automated driving control device 100, a travel driving force output device 200, a brake device 210, and a steering device 220. These units or devices are connected to each other by a multiplex communication line such as a controller area network (CAN) communication line, a serial communication line, a wireless communication network, or the like. The configuration shown in FIG. 1 is merely an example, and a part of the configuration may be omitted or another configuration may be added. The automated driving control device 100 is an example of the “vehicle control device”

The camera 10 is, for example, a digital camera using a solid-state imaging device such as a charge coupled device (CCD) or a complementary metal oxide semiconductor (CMOS). The camera 10 is attached to any place on the vehicle in which the vehicle system 1 is mounted (hereinafter referred to as a subject vehicle M). In the case of forward imaging, the camera 10 is attached to an upper portion of a front windshield, a rear surface of a rearview mirror, or the like. The camera 10, for example, periodically and repeatedly images the periphery of the subject vehicle M. The camera 10 may be a stereo camera.

The radar device 12 radiates radio waves such as millimeter waves to the surroundings of the subject vehicle M and detects radio waves (reflected waves) reflected by an object to detect at least a position (a distance and orientation) of the object. The radar device 12 is attached to any place on the subject vehicle M. The radar device 12 may detect a position and a speed of the object using a frequency modulated continuous wave (FM-CW) scheme.

The finder 14 is a light detection and ranging (LIDAR). The finder 14 radiates light around the subject vehicle M and measures scattered light. The finder 14 detects a distance to a target on the basis of a time from light emission to light reception. The radiated light is, for example, pulsed laser light. The finder 14 is attached to any place on the subject vehicle M.

The object recognition device 16 performs a sensor fusion process on detection results of some or all of the camera 10, the radar device 12, and the finder 14 to recognize a position, type, speed, and the like of the object. The object recognition device 16 outputs recognition results to the automated driving control device 100. The object recognition device 16 may output the detection results of the camera 10, the radar device 12, or the finder 14 as they are to the automated driving control device 100. The object recognition device 16 may be omitted from the vehicle system 1.

The communication device 20, for example, communicates with another vehicle near the subject vehicle M using a cellular network, a Wi-Fi network, Bluetooth (registered trademark), dedicated short range communication (DSRC), or the like or communicates with various server devices via a wireless base station.

The HMI 30 presents various types of information to an occupant of the subject vehicle M and receives an input operation from the occupant. The HMI 30 includes various display devices, speakers, buzzers, touch panels, switches, keys, and the like. Examples of the switch include a changeover switch that switches a driving mode of the subject vehicle M between a first driving mode and a second driving mode.

The vehicle sensor 40 includes, for example, a vehicle speed sensor that detects a speed of the subject vehicle M, an acceleration sensor that detects acceleration, a yaw rate sensor that detects an angular speed around a vertical axis, and an orientation sensor that detects a direction of the subject vehicle M. An example of the vehicle sensor 40 may include a seat position detection sensor that detects a position of a driver's seat on which the occupant is seated.

The navigation device 50 includes, for example, a global navigation satellite system (GNSS) receiver 51, a navigation HMI 52, and a route determination unit 53. The navigation device 50 holds first map information 54 in a storage device such as a hard disk drive (HDD) or a flash memory. The GNSS receiver 51 specifies a position of the subject vehicle M on the basis of a signal received from a GNSS satellite. The position of the subject vehicle M may be specified or supplemented by an inertial navigation system (INS) using an output of the vehicle sensor 40. The navigation HMI 52 includes a display device, a speaker, a touch panel, keys, and the like. The navigation HMI 52 may be partly or wholly shared with the above-described HMI 30. The route determination unit 53, for example, determines a route (hereinafter, an on-map route) from the position of the subject vehicle M (or any input position) specified by the GNSS receiver 51 to a destination input by the occupant using the navigation HMI 52 by referring to the first map information 54. The first map information 54 is, for example, information in which a road shape is represented by links indicating roads and nodes connected by the links. The first map information 54 may include a curvature of the road, point of interest (POI) information, and the like. The on-map route is output to the MPU 60. The navigation device 50 may perform route guidance using the navigation HMI 52 on the basis of the on-map route. The navigation device 50 may be realized, for example, by a function of a terminal device such as a smartphone or a tablet terminal possessed by the occupant. The navigation device 50 may transmit a current position and a destination to a navigation server via the communication device 20 and acquire the same route as the on-map route from the navigation server.

The MPU 60 includes, for example, a recommended lane determination unit 61 and holds second map information 62 in a storage device such as an HDD or a flash memory. The recommended lane determination unit 61 divides the on-map route provided from the navigation device 50 into a plurality of blocks (for example, divides the route every 100 [m] in a progression direction of the vehicle) and determines a recommended lane for each block by referring to the second map information 62. The recommended lane determination unit 61 determines in which lane from the left the subject vehicle M travels. The recommended lane determination unit 61 determines the recommended lane so that the subject vehicle M can travel on a reasonable route for progression to a branch destination in a case that there is a branch place in the on-map route.

The second map information 62 is map information with higher accuracy than the first map information 54. The second map information 62 includes, for example, information on a center of the lane or information on a boundary of the lane. The second map information 62 may include road information, traffic regulation information, address information (an address and postal code), facility information, telephone number information, and the like. The second map information 62 may be updated at any time by the communication device 20 communicating with another device.

The driving operator 80 includes, for example, an accelerator pedal, a brake pedal, a shift lever, a steering wheel, a modified steering wheel, a joystick, and other operators. A sensor that detects the amount of operation or the presence or absence of the operation is attached to the driving operator 80, and a result of the detection is output to some or all of the automated driving control device 100, the travel driving force output device 200, the brake device 210, and the steering device 220.

The automated driving control device 100 includes, for example, a first control unit 120 and a second control unit 160. Each of these components is realized, for example, by a hardware processor such as a central processing unit (CPU) executing a program (software). Some or all of these components may be realized by hardware (a circuit unit; including circuitry) such as a large scale integration (LSI), an application specific integrated circuit (ASIC), a field-programmable gate array (FPGA), or a graphics processing unit (GPU) or may be realized by software and hardware in cooperation. The program may be stored in a storage device such as an HDD or a flash memory of the automated driving control device 100 in advance or may be stored in a removable storage medium such as a DVD or a CD-ROM and the storage medium may be mounted in a drive device so that the program may be installed in the HDD or the flash memory of the automated driving control device 100. A combination of the action plan generation unit 140 and the second control unit 160 is an example of the “driving control unit”. The driving control unit executes driving control in the first driving mode or the second driving mode on the basis of, for example, the surrounding situation recognized by the recognition unit 130.

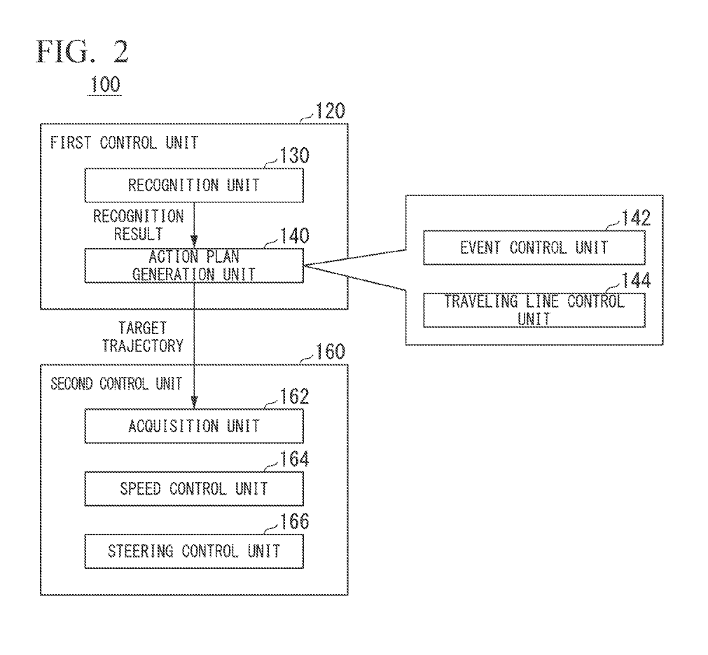

FIG. 2 is a functional configuration diagram of the first control unit 120 and the second control unit 160. The first control unit 120 includes, for example, a recognition unit 130 and an action plan generation unit 140. The action plan generation unit 140 includes, for example, an event control unit 142 and a traveling line control unit 144. The event control unit 142 is an example of a “switching control unit”. The first control unit 120 realizes, for example, a function on the basis of artificial intelligence (AI) and a function on the basis of a previously given model in parallel. For example, in a function of “recognizing an intersection,” recognition of the intersection using deep learning or the like and recognition on the basis of previously given conditions (a signal which can be subjected to pattern matching, a road sign, or the like) are executed in parallel, and the function of recognizing an intersection is realized by scoring both recognitions and comprehensively evaluating the recognitions. Accordingly, the reliability of automated driving is guaranteed.

The recognition unit 130 recognizes a state such as a position, speed, or acceleration of an object near the subject vehicle M on the basis of information input from the camera 10, the radar device 12, and the finder 14 via the object recognition device 16. Examples of the object include a moving body, such as a pedestrian, a bicycle, or another vehicle, or an obstacle, such as a construction place. The position of the object, for example, is recognized as a position at absolute coordinates with a representative point (a centroid, a drive shaft center, or the like) of the subject vehicle M as an origin and is used for control. The position of the object may be represented by a representative point such as a centroid or a corner of the object or may be represented by a represented area. In a case that the object is another vehicle, the “state” of the object may include an acceleration or jerk of the object, or an “action state” (for example, whether the object is changing a lane or is about to change a lane). In a case that the object is a pedestrian, the “state” of the object may include a direction in which the object moves or an “action state” (for example, whether or not the object is crossing a road or is about to cross the road).

The recognition unit 130, for example, recognizes a lane (road) in which the subject vehicle M is traveling. For example, the recognition unit 130 compares a pattern of a road marking line (for example, an arrangement of a solid line and a broken line) obtained from the second map information 62 with a pattern of a road marking line near the subject vehicle M recognized from an image captured by the camera 10 to recognize the traveling lane. The recognition unit 130 may recognize not only the road marking lines but also a traveling road boundary (a road boundary) including the road marking line, a road shoulder, a curb, a median strip, a guard rail, or the like to recognize the traveling lane. The recognition unit 130 may recognize the number of lanes along which the subject vehicle M can progress in the same direction. In this recognition, the position of the subject vehicle M acquired from the navigation device 50 or a processing result of an INS may be added. The recognition unit 130 recognizes a width of the road on which the subject vehicle M travels. In this case, the recognition unit 130 may recognize a road width from the image captured by the camera 10 or may recognize a road width from the road marking lines obtained from the second map information 62. The recognition unit 130 may recognize a width (for example, a width of the other vehicle), a height, a vehicle length, a shape, or the like of an obstacle on the basis of the image captured by the camera 10. The recognition unit 130 recognizes a temporary stop line, a red light, a road sign, a toll gate, and other road events.

The recognition unit 130 recognizes a position or a posture of the subject vehicle M relative to the traveling lane when recognizing the traveling lane. The recognition unit 130 may recognize, for example, a deviation of a representative point of the subject vehicle M from a center of the lane and an angle formed between a progression direction of the subject vehicle M and a line connecting a center of the lane as a relative position and a posture of the subject vehicle M with respect to the traveling lane. Instead, the recognition unit 130 may recognize, for example, a position of the representative point of the subject vehicle M with respect to any one of side end portions (the road marking line or the road boundary) of the traveling lane as the relative position of the subject vehicle M with respect to the traveling lane. The recognition unit 130 may recognize a structure (for example, a utility pole or a median strip) on the road on the basis of the first map information 54 or the second map information 62. The recognition unit 130 may recognize a passenger gate, through which other vehicles, pedestrians, or the like enter and exit from a site adjacent to the traveling lane owned by an individual or a company. The recognition unit 130 may recognize opening and closing of the passenger gate.

In principle, the action plan generation unit 140 generates a target trajectory along which the subject vehicle M will travel in the future automatically (without depending on an operation of a driver) so that the subject vehicle M can travel on the recommended lane determined by the recommended lane determination unit 61 and cope with a surrounding situation of the subject vehicle M. The target trajectory is a target trajectory through which the representative point of the subject vehicle M passes. The representative point is, for example, a centroid of the subject vehicle M. Hereinafter, description will be given using the centroid. The target trajectory includes, for example, a speed element. For example, the target trajectory is represented as a sequence of points (trajectory points) to be reached by the subject vehicle M. The trajectory point is a point that the subject vehicle M is to reach for each predetermined travel distance (for example, several meters) at a road distance, and a target speed and a target acceleration at every predetermined sampling time (for example, several tenths of a [sec]) are separately generated as part of the target trajectory. The trajectory point may be a position that the subject vehicle M is to reach at the sampling time at every predetermined sampling time. In this case, information on the target speed or the target acceleration is represented by the interval between the trajectory points. Functions of the event control unit 142 and the traveling line control unit 144 of the action plan generation unit 140 will be described below.

The second control unit 160 controls the travel driving force output device 200, the brake device 210, and the steering device 220 so that the subject vehicle M passes through the target trajectory generated by the action plan generation unit 140 at a scheduled time.

The second control unit 160 includes, for example, an acquisition unit 162, a speed control unit 164, and a steering control unit 166. The acquisition unit 162 acquires information on the target trajectory (trajectory points) generated by the action plan generation unit 140 and stores the information on the target trajectory in a memory (not shown). The speed control unit 164 controls the travel driving force output device 200 or the brake device 210 on the basis of the speed element incidental to the target trajectory stored in the memory. The steering control unit 166 controls the steering device 220 according to a degree of curvature of the target trajectory stored in the memory. Processes of the speed control unit 164 and the steering control unit 166 are realized by, for example, a combination of feedforward control and feedback control. For example, the steering control unit 166 executes a combination of feedforward control according to a curvature of a road in front of the subject vehicle M and feedback control on the basis of a deviation from the target trajectory.

The travel driving force output device 200 outputs a travel driving force (torque) for traveling of the vehicle to the driving wheels. The travel driving force output device 200 includes, for example, a combination of an internal combustion engine, an electric motor, a transmission, and the like and an ECU that controls these. The ECU controls the above configuration according to information input from the second control unit 160 or information input from the driving operator 80.

The brake device 210 includes, for example, a brake caliper, a cylinder that transfers hydraulic pressure to the brake caliper, an electric motor that generates hydraulic pressure in the cylinder, and a brake ECU. The brake ECU controls the electric motor according to information input from the second control unit 160 or information input from the driving operator 80 so that a brake torque according to a braking operation is output to each wheel. The brake device 210 may include a mechanism that transfers the hydraulic pressure generated by the operation of the brake pedal included in the driving operator 80 to the cylinder via a master cylinder as a backup. The brake device 210 is not limited to the configuration described above and may be an electronically controlled hydraulic brake device that controls the actuator according to information input from the second control unit 160 and transfers the hydraulic pressure of the master cylinder to the cylinder.

The steering device 220 includes, for example, a steering ECU and an electric motor. The electric motor, for example, changes a direction of the steerable wheels by causing a force to act on a rack and pinion mechanism. The steering ECU drives the electric motor according to information input from the second control unit 160 or information input from the driving operator 80 to change the direction of the steerable wheels.

[Function of Event Control Unit]

In principle, the event control unit 142 determines events to be sequentially executed in automated driving so that the subject vehicle M can travel in the recommended lane determined by the recommended lane determination unit 61 and cope with a surrounding situation of the subject vehicle M. Examples of events of automated driving include a constant speed traveling event in which a vehicle travels on the same traveling lane at a constant speed, a following driving event in which a vehicle follows a preceding vehicle, an overtaking event in which a vehicle overtakes a preceding vehicle, an avoidance event in which a vehicle performs braking and/or steering to avoid approaching an obstacle, a curve traveling event in which a vehicle travels at a curve, a passing event in which a vehicle passes through a predetermined point such as a crossing, a crosswalk, or a railway crossing, a lane changing event, a merging event, a branching event, an automatic stop event, and a takeover event for ending the first driving mode and switching a driving mode to the second driving mode. The event control unit 142 generates a target trajectory along which the subject vehicle M is to travel in the future according to the determined event.

[Function of Traveling Line Control Unit]

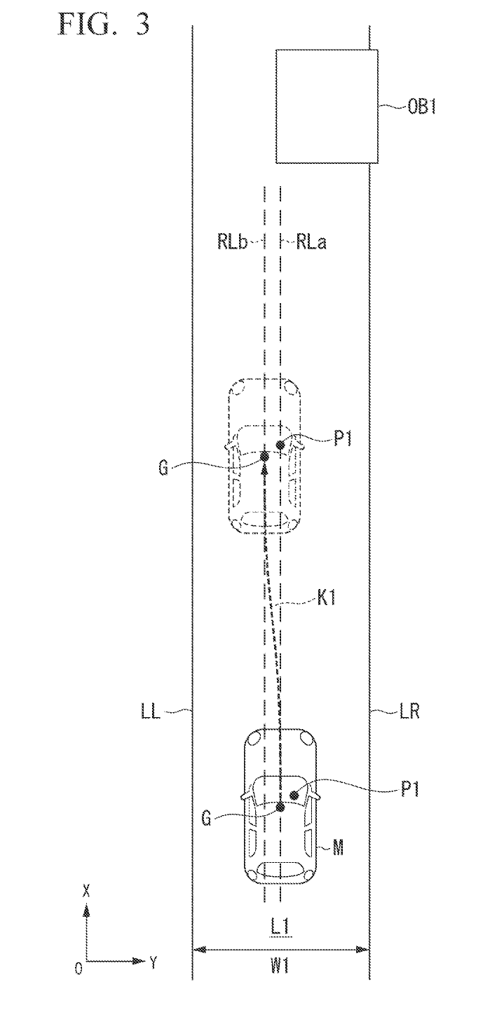

The traveling line control unit 144 performs driving control for setting traveling lines (a first traveling line and a second traveling line) on which the subject vehicle M travels in each of the first driving mode and the second driving mode and causing the subject vehicle M to travel along the set traveling line. FIG. 3 is a diagram showing an example of a process of the traveling line control unit 144. In the example of FIG. 3, it is assumed that the subject vehicle M is traveling in a lane L1 partitioned by right and left road marking lines LL and LR.

In the example of FIG. 3, the traveling line control unit 144 makes a first traveling line RLa, on which the subject vehicle M travels in the first driving mode, and a second traveling line RLb, on which the subject vehicle M travels in the second driving mode, different. Both of the first traveling line RLa and the second traveling line RLb are lines through which the centroid G of the subject vehicle M passes.

For example, the traveling line control unit 144 sets the first traveling line RLa that passes through a center in a road width direction (a lateral direction; a Y direction in FIG. 3) of the lane L1. In a case that the first driving mode is executed, the traveling line control unit 144 generates a target trajectory, along which the centroid G of the subject vehicle M passes through a first traveling line Rla, and causes the subject vehicle M to travel along the generated target trajectory. Accordingly, in the first driving mode, the camera 10, the radar device 12, and the finder 14 mounted in the subject vehicle M can substantially evenly recognize left and right surrounding situations from the center of the lane. Therefore, it is possible to improve visibility of the surroundings of the subject vehicle M by the recognition unit 130.

The traveling line control unit 144, for example, sets the second traveling line RLb so that a position P1 of the occupant of the subject vehicle M passes through the center in the road width direction of the lane L1. The position P1 of the occupant is, for example, a position of the driver's seat provided in the subject vehicle M. Therefore, in a case that a steering wheel of the subject vehicle M is provided on the right side as viewed from the vehicle cabin, the second traveling line RLb is offset to the left side relative to the first traveling line RLa.

The traveling line control unit 144 may change the position P1 of the occupant in a case that the position of the driver's seat is changed by a sliding operation or the like of the occupant. The traveling line control unit 144 may set the position P1 of the occupant on the basis of a position of a pillar (for example, an A pillar) supporting a ceiling portion (a roof) of the subject vehicle M. The traveling line control unit 144 may set the position P1 of the occupant on the basis of a height (a sitting height), a position of a head portion, and the like of the occupant imaged by an in-vehicle camera (not shown) or the like.

The traveling line control unit 144 may set the position P1 of the occupant according to an operation of the HMI 30 of the occupant. The traveling line control unit 144 may acquire, for each occupant, the position P1 of the occupant in the road width direction at the time of manual driving in the past and set the position P1 of the occupant using, for example, an average value or a standard deviation of the acquired position. Accordingly, it is possible to set the position P1 of the occupant corresponding to preference of each occupant.

For example, in a case that the takeover event is executed by the event control unit 142, the traveling line control unit 144 executes control for switching the driving mode of the subject vehicle M from the first driving mode to the second driving mode. Conditions under which the takeover event is executed by the event control unit 142 will be described herein. The event control unit 142 executes the takeover event, for example, when at least one of conditions (1) to (5) to be described below is satisfied.

<Condition (1)>

The event control unit 142 executes a takeover event, for example, in a case in which an obstacle occurs in a progression direction of the subject vehicle M. The case in which an obstacle occurs is, for example, a case in which the subject vehicle M cannot travel without deviating from the lane L1 because there is an obstacle OB1 in a progression direction of the subject vehicle M, as shown in FIG. 3. The case in which the obstacle occurs may be a case in which the subject vehicle M cannot travel, for example, because at least a part of a road has a crack or a depression.

<Condition (2)>

The event control unit 142 executes a takeover event in a case that a disturbance element of the lane L1 is equal to or larger than a predetermined amount. Examples of the disturbance element include the number of other traffic participants (for example, pedestrians or bicycles) in the progression direction of the subject vehicle M, attributes of other traffic participants, the number of intersecting roads in a predetermined distance section, and the number of entrances to houses or the like connected to a traveling lane. For example, the event control unit 142 recognizes the disturbance element described above on the basis of detection results of some or all of the camera 10, the radar device 12, and the finder 14. The event control unit 142 may collate the position information of the subject vehicle M with position information of map information (the first map information 54 and the second map information 62) and recognize the disturbance element from a road shape corresponding to the matching position information. For example, when the number of other traffic participants which are disturbance elements is equal to or greater than five or when the number of roads crossing the lane L1 in a predetermined distance section is equal to or greater than three, the event control unit 142 executes a takeover event. The event control unit 142 may determine whether to execute the takeover event on the basis of a combination of a plurality of disturbance elements.

<Condition (3)>

The event control unit 142 executes a takeover event, for example, in a case that a degree of recognition of the recognition unit 130 becomes equal to or lower than a predetermined degree due to an influence of weather such as heavy rain.

<Condition (4)>

The event control unit 142 executes a takeover event, for example, in a case that an instruction to switch from the first driving mode to the second driving mode is received due to an operation of a mode changeover switch of the occupant.

<Condition (5)>

For example, in a case that a passenger gate adjacent to the lane L1 is recognized by the recognition unit 130, the event control unit 142 executes a takeover event. In this case, when it is recognized that the passenger gate is open, the event control unit 142 may execute the takeover event because other vehicles, pedestrians, or the like are likely to enter the lane L1 from that position. When the passenger gate is closed, the event control unit 142 may not execute the takeover event.

With the execution of the takeover event in the event control unit 142, the traveling line control unit 144 generates a target trajectory K1 for changing the centroid G of the subject vehicle M from on the first traveling line RLa to on the second traveling line RLb and causes the subject vehicle M to travel along the generated target trajectory Kl. As a result, the traveling line of the subject vehicle M is switched from the first traveling line RLa to the second traveling line RLb. Then, in a state in which the centroid G of the subject vehicle M is moving on the second traveling line, the traveling line control unit 144 notifies the occupant of a takeover request for operating the driving operator 80 to execute manual driving. After the takeover request is notified of, the traveling line control unit 144 ends the first driving mode and executes the second driving mode in a case that an operation of the driving operator 80 by the occupant is received.

Accordingly, when the subject vehicle M starts the second driving mode, the position P1 of the occupant is located at the center in the road width direction of the lane L1, and therefore, it is possible to allow the occupant to visually recognize left and right situations of the subject vehicle M in a well-balanced manner, as compared with a case in which the centroid G of the subject vehicle M is located at the center of the lane L1 in the road width direction.

For example, in a case that the LKAS is executed as the second driving mode, the traveling line control unit 144 performs steering control so that the centroid G of the subject vehicle M is located on the second traveling line RLb. As a result, the occupant can continue to visually recognize the surrounding situation in a well-balanced manner from the center of the traveling lane.

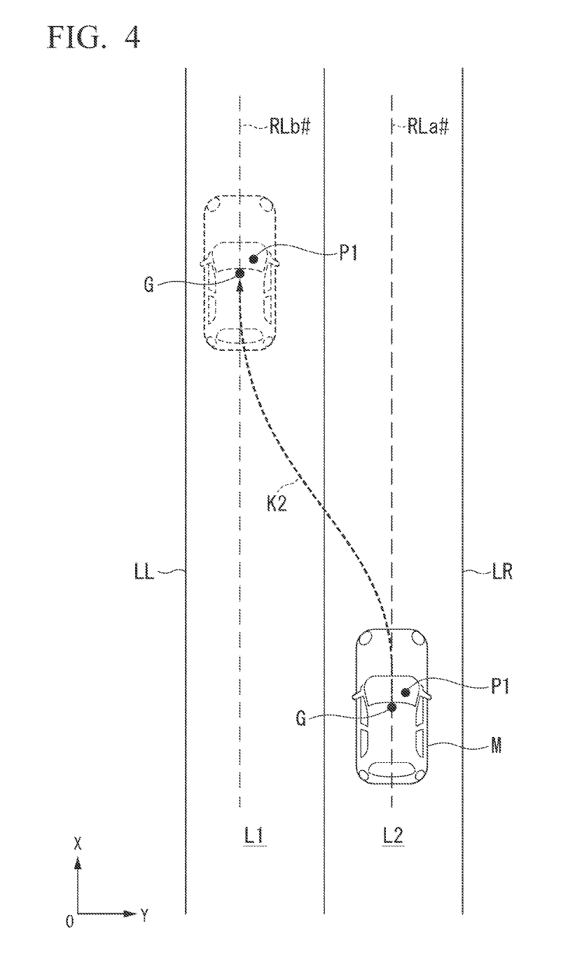

The traveling line control unit 144 may set the first traveling line RLa and the second traveling line RLb to different lanes, instead of setting the first traveling line RLa and the second traveling line RLb to the same lane L1, in a case that the number of traveling lanes for the subject vehicle M recognized by the recognition unit 130 is equal to or greater than two. FIG. 4 is a diagram showing an example of a process of the traveling line control unit 144 in a case in which the number of lanes in which the subject vehicle M travels is two. In the example of FIG. 4, it is assumed that there are two lanes L1 and L2. The lane L2 is assumed to be an overtaking lane that is used for a vehicle to overtake a vehicle traveling in the lane L1. Therefore, the vehicle traveling in the lane L2 travels at a higher speed than the vehicle traveling in the lane L1.

In a case that the traveling line control unit 144 causes the vehicle to travel in the lane L2 in the first driving mode, the traveling line control unit 144 sets a first traveling line RLa# to pass through a center in a road width direction (a lateral direction; a Y direction in FIG. 4) of the lane L2. The traveling line control unit 144 causes the subject vehicle M to travel so that the centroid G of the subject vehicle M passes through the first traveling line RLa#.

For example, in a case that a takeover event is executed by the event control unit 142, the traveling line control unit 144 sets a second traveling line RLb# of the subject vehicle M so that the position P1 of the occupant is located at the center in the road width direction of the lane L1, which is a slower lane than the lane L2. Before driving in the second driving mode is started, the traveling line control unit 144 generates a target trajectory K2 of the subject vehicle M so that the centroid G of the subject vehicle M passes through the second traveling line RLb# and causes the subject vehicle M to travel along the generated target trajectory K2. After the traveling line of the subject vehicle M is switched from the first traveling line RLa# to the second traveling line, the traveling line control unit 144 switches the driving mode of the subject vehicle M from the first driving mode to the second driving mode.

Accordingly, since the subject vehicle M is traveling in the lane L1 at a point in time when the occupant starts an operation of one or both of the steering and the acceleration/deceleration of the subject vehicle M in the second driving mode, the occupant can have a margin of the operation as compared with the case in which the subject vehicle M is traveling in the lane L2. Since the position P1 of the occupant is located at the center of the lane L1, it is possible to allow the occupant to visually recognize right and left situations of the lane L1 in a well-balanced manner.

In a case that switching is performed from the second driving mode to the first driving mode, the traveling line control unit 144 generates a target trajectory along which the centroid G of the subject vehicle M passes through the center of the lane and causes the subject vehicle M to travel along the generated target trajectory.

[Flow of Process]

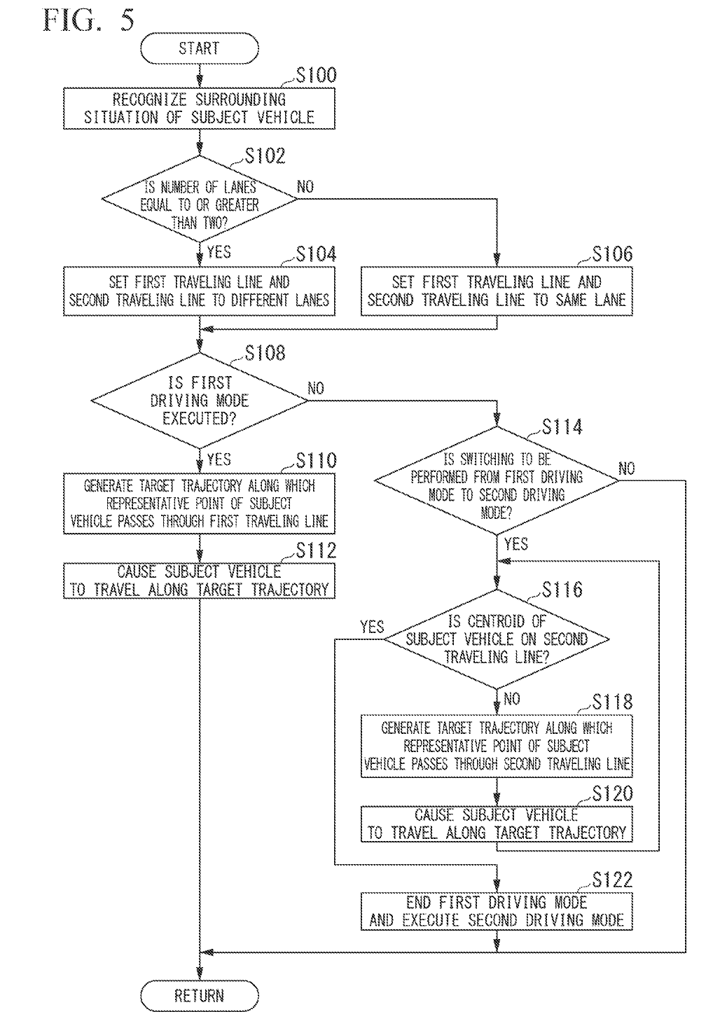

FIG. 5 is a flowchart showing an example of a flow of a process that is executed by the automated driving control device 100 according to the embodiment. The process of this flowchart may be repeatedly executed at a predetermined cycle or at a predetermined timing, for example.

In the example of FIG. 5, the recognition unit 130 recognizes a surrounding situation of the subject vehicle M (step S100). Then, the recognition unit 130 determines whether or not the number of lanes on which the subject vehicle M can progress in a progression direction is equal to or greater than two (step S102). In a case that it is determined that the number of lanes is equal to or greater than two, the traveling line control unit 144 sets a first traveling line and a second traveling line to different lanes (step S104). In a case that it is determined that the number of lanes is not equal to or greater than two, the traveling line control unit 144 sets the first traveling line and the second traveling line to the same lane (step S106).

Next, the event control unit 142 determines whether or not the subject vehicle M executes the first driving mode (step S108). In a case that it is determined that the subject vehicle M executes the first driving mode, the traveling line control unit 144 generates a target trajectory along which the representative point of the subject vehicle M passes through the first traveling line (step S110) and causes the subject vehicle M to travel along the generated target trajectory (step S112).

In a case that it is determined in the process of step S108 that the subject vehicle M does not execute the first driving mode, the traveling line control unit 144 determines whether or not switching is to be performed from the first driving mode to the second driving mode (step S114). In a case that it is determined that switching is to be performed from the first driving mode to the second driving mode, the traveling line control unit 144 determines whether or not the representative point of the subject vehicle M is on the second traveling line (step S116).

In a case that it is determined that the representative point of the subject vehicle M is not on the second traveling line, the traveling line control unit 144 generates a target trajectory along which the representative point of the subject vehicle M passes through the second traveling line (step S118), causes the subject vehicle M to travel along the generated target trajectory (step S120), and returns to the process of step S116. In a case that it is determined in the process of step S116 that the representative point of the subject vehicle M is on the second traveling line, the traveling line control unit 144 ends the first driving mode and executes the second driving mode (step S122). In the process of S122, the traveling line control unit 144 may perform steering control so that the subject vehicle M travels while the representative point of the subject vehicle M passes through the second traveling line. Accordingly, a process of this flowchart ends. In the process of step S114, in a case that switching is not to be performed from the first driving mode to the second driving mode, the second driving mode is continued. Accordingly, the process of this flowchart ends.

According to the embodiment described above, the vehicle control device includes the recognition unit (130) that recognizes a surrounding situation of the subject vehicle M, the driving control unit (the action plan generation unit 140 and the second control unit 160) that executes the first driving mode in which steering, acceleration, and deceleration of the subject vehicle M are controlled without dependence on an operation of an occupant or the second driving mode in which a degree of dependence on the operation of the occupant is higher than the first driving mode on the basis of the surrounding situation recognized by the recognition unit (130), and the switching control unit (the event control unit 142) that switches between the first driving mode and the second driving mode when a predetermined condition is satisfied, wherein the driving control unit switches the traveling line of the subject vehicle M from the first traveling line on which the subject vehicle M travels in the first driving mode to the second traveling line on which the subject vehicle M travels in the second driving mode and then switches the driving mode of the subject vehicle M from the first driving mode to the second driving mode such that more appropriate travel control can be realized at the time of switching between the driving modes.

For example, various sensors for recognizing the surroundings of the subject vehicle M are often provided bilaterally symmetrical with respect to a central axis of the subject vehicle M, and a seating position of the driver is not on a center axis of the subject vehicle M. Therefore, according to the embodiment, it is possible to improve recognition of the surroundings in each mode by changing the traveling line between the first driving mode and the second driving mode. More specifically, according to the embodiment, when the second driving mode is executed, the position of the occupant is located at the center of the lane such that the visibility of the surrounding situation of the occupant can be improved.

[Hardware Configuration]

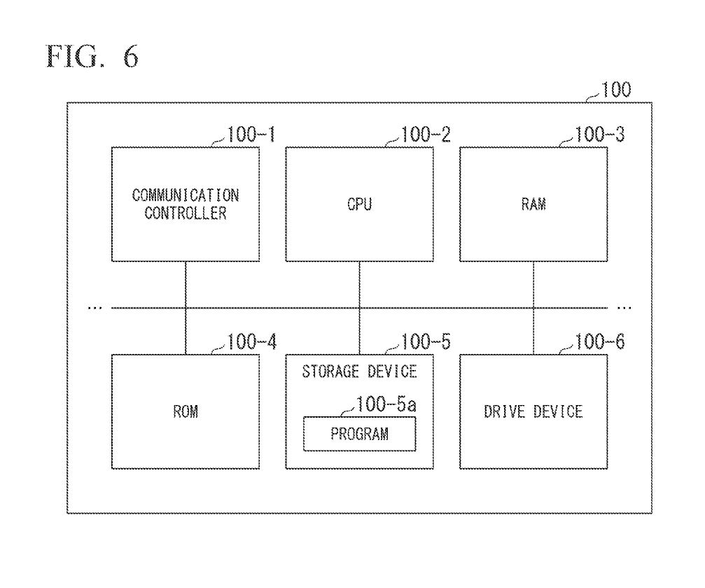

FIG. 6 is a diagram showing an example of a hardware configuration of the automated driving control device 100 according to the embodiment. As shown in FIG. 6, the automated driving control device 100 has a configuration in which a communication controller 100-1, a CPU 100-2, a RAM 100-3 that is used as a work memory, a ROM 100-4 that stores a boot program or the like, a storage device 100-5 such as a flash memory or an HDD, a drive device 100-6, and the like are connected to each other by an internal bus or a dedicated communication line. The communication controller 100-1 communicates with components other than the automated driving control device 100. A portable storage medium (for example, a computer-readable non-transient storage medium) such as an optical disc is mounted in the drive device 100-6. A program 100-5a to be executed by the CPU 100-2 is stored in the storage device 100-5. This program is developed in the RAM 100-3 by a direct memory access (DMA) controller (not shown) or the like and executed by the CPU 100-2. Further, a program 100-5a referred to by the CPU 100-2 may be stored in the portable storage medium mounted in the drive device 100-6 or may be downloaded from another device via a network. Accordingly, some or all of the first control unit 120 and the second control unit 160 of the automated driving control device 100 are realized.

The embodiment described above can be represented as follows.

A vehicle control device including

a storage device that stores a program, and

a hardware processor,

wherein the hardware processor is configured to

recognize a surrounding situation of a vehicle,

execute a first driving mode in which steering, acceleration, and deceleration of the vehicle are controlled without dependence on an operation of an occupant or a second driving mode in which a degree of dependence on the operation of the occupant is higher than the first driving mode on the basis of the recognized surrounding situation,

switch between the first driving mode and the second driving mode when a predetermined condition is satisfied, and

switch a traveling line of the vehicle from a first traveling line on which the vehicle travels in the first driving mode to a second traveling line on which the vehicle travels in the second driving mode and then switch a driving mode of the vehicle from the first driving mode to the second driving mode by executing the program stored in the storage device.

Although a mode for carrying out the present invention has been described above using the embodiment, the present invention is not limited to the embodiment at all, and various modifications and substitutions may be made without departing from the spirit of the present invention.

What is claimed is:

1. A vehicle control device comprising:
a recognition unit that recognizes a surrounding situation of a vehicle;
a driving control unit that executes, on the basis of the surrounding situation recognized by the recognition unit, a first driving mode in which steering, acceleration, and deceleration of the vehicle are controlled without dependence on an operation of an occupant or a second driving mode in which a degree of dependence on the operation of the occupant is higher than the first driving mode; and
a switching control unit that switches between the first driving mode and the second driving mode when a predetermined condition is satisfied,
wherein the driving control unit switches a traveling line of the vehicle from a first traveling line on which the vehicle travels in the first driving mode to a second traveling line on which the vehicle travels in the second driving mode and then switches a driving mode of the vehicle from the first driving mode to the second driving mode.

2. The vehicle control device according to claim 1, wherein the driving control unit sets the first traveling line and the second traveling line to the same lane.

3. The vehicle control device according to claim 1, wherein the driving control unit sets the first traveling line and the second traveling line to different lanes in a case that the number of traveling lanes of the vehicle recognized by the recognition unit is equal to or greater than two.

4. The vehicle control device according to claim 1, wherein the switching control unit executes control for switching the driving mode of the vehicle from the first driving mode to the second driving mode in a case that an obstacle in a progression direction of the vehicle is recognized by the recognition unit.

5. The vehicle control device according to claim 1, wherein the switching control unit executes control for switching the driving mode of the vehicle from the first driving mode to the second driving mode in a case that a disturbance element of a road on which the vehicle travels, which is recognized by the recognition unit, is equal to or larger than a predetermined amount.

6. A vehicle control method comprising:
recognizing, by a vehicle control device, a surrounding situation of a vehicle;
executing, by the vehicle control device, a first driving mode in which steering, acceleration, and deceleration of the vehicle are controlled without dependence on an operation of an occupant or a second driving mode in which a degree of dependence on the operation of the occupant is higher than the first driving mode on the basis of the recognized surrounding situation;
switching, by the vehicle control device, between the first driving mode and the second driving mode when a predetermined condition is satisfied; and
switching, by the vehicle control device, a traveling line of the vehicle from a first traveling line on which the vehicle travels in the first driving mode to a second traveling line on which the vehicle travels in the second driving mode and then switching a driving mode of the vehicle from the first driving mode to the second driving mode.

7. A computer-readable non-transient storage medium storing a program, the program causing a vehicle control device to:
recognize a surrounding situation of a vehicle;
execute a first driving mode in which steering, acceleration, and deceleration of the vehicle are controlled without dependence on an operation of an occupant or a second driving mode in which a degree of dependence on the operation of the occupant is higher than the first driving mode on the basis of the recognized surrounding situation;
switch between the first driving mode and the second driving mode when a predetermined condition is satisfied; and
switch a traveling line of the vehicle from a first traveling line on which the vehicle travels in the first driving mode to a second traveling line on which the vehicle travels in the second driving mode and then switch a driving mode of the vehicle from the first driving mode to the second driving mode.
